(19) United States
(12) Patent Application Publication
(10) Pub. No.: US 2017/0107972 A1
(43) Pub. Date: Apr. 20, 2017

(54) VERTICAL WIND TURBINE

(71) Applicant: KING FAHD UNIVERSITY OF PETROLEUM AND MINERALS, Dharhan (SA)

(72) Inventors: ALLAN TUBAILEH, NABLUS (PS); HUSAM WALWIL, WEST BANK (PS)

(21) Appl. No.: 14/883,575

(22) Filed: Oct. 14, 2015

(51) Int. Cl. F03D 3/04; F03D 3/00

(52) U.S. Cl. CPC F03D 3/0454; F03D 3/005; F05B 2240/213

(57) ABSTRACT

The vertical wind turbine is provided with a rotating vane housing mounted between an upper, cam disk and a lower, base disk, the base disk being mounted to a shaft. A plurality of turbine blades are pivotally mounted around the vane housing, each of the blades being pivotal between open and closed positions with respect to the housing. The cam disk defines a cam profile. A roller follower is coupled to each turbine blade. The follower forces the connected blade to open or close as the follower travels along the cam profile during each revolution of the housing. The open position of the blade harnesses wind energy to induce torque for rotating the housing. The closed position of the blade reduces drag to increase efficiency of the vertical wind turbine.

### BACKGROUND OF THE INVENTION

1. Field of the Invention

The present invention relates to energy generators, and particularly to a vertical wind turbine of the Savonius-type that provides increased efficiency in converting wind energy into usable energy.

2. Description of the Related Art

Alternative energy plays an important role in the worldwide economy and the living conditions in current times. Some of these alternative energy solutions and the production thereof include solar energy, wave energy, geothermal energy, and wind energy.

Wind turbines are a common device for generating energy by harnessing the kinetic energy of the wind into mechanical energy, and then into electricity. As electricity generators, wind turbines can be connected to electrical networks, such as battery charging circuits, power systems, and large utility grids. The performance of a wind turbine can be related to three points on a velocity scale. The first point is the cut-in speed which is the minimum speed required to deliver useful power. The second point is the rated wind speed, which is the wind speed at which the rated power is reached. The third point is the cut-out speed, which is the maximum speed at which the turbine is allowed to deliver power. Wind turbines are mainly classified into two types according to the orientation of the rotor, a horizontal axis wind turbine (HAWT) and a vertical axis wind turbine (VAWT).

The HAWT-type of wind turbine includes a rotor in which the axis of rotation is parallel to the ground and to the wind stream, and the generator is usually disposed on top of a tower. Most modern HAWT have a propeller-type rotor having a plurality of airfoil blades. This configuration converts the linear motion of the wind into rotational energy by the wind acting against the airfoil blades. The airfoil blades are designed much like the wings of an airplane to create areas of high pressure and low pressure as the wind passes over the airfoil blades. The pressure differential creates lift that pushes the airfoil blades. As a result, the movement of the airfoil blades rotates the rotator. A certain amount of force acts in opposition to the lift force, and this force is referred to as drag. Drag diminishes the actual amount of lift force acting on the airfoil blades, which lowers the power-generating potential or efficiency of the turbine. Thus, a relatively high lift-to-drag ratio is preferred.

The VAWT-type of wind turbine includes a rotor in which the axis of rotation is perpendicular with respect to the ground and the wind stream. The generator and gearbox are typically located in the base of the wind turbine, which is easier for maintenance. Such turbines do not need an orientation mechanism because the turbine rotates from the action of the wind, no matter from which direction the wind impacts the VAWT. However, these VAWTs tend to rotate at lower speeds. One of the main issues associated with VAWTs is the relatively large torque generated during operation. This tends to lead to higher failure rates and operation at lower efficiency compared to HAWTs.

One common type of VAWT is named after a Finnish engineer, Sigurd Johannes Savonius, ca. 1922. An example of a Savonius wind turbine S is shown in FIG. 5. This vertical axis wind turbine S typically consists of two or three hollow, almost cylindrically shaped blades B attached to a shaft or vertical axis A. The drag coefficient for a flow perpendicular to the concave face is greater than that for a convex face. The drag differential between the concave and the convex surfaces results in a torque that turns the rotor R. A variant of the Savonius wind turbine S has the blades B extending from a radial point offset from the axis of rotation creating a gap therebetween. The gap between the blades B allows wind to thrust out the back end of one blade B to act against the concave face of the adjacent blade B and assist in rotation of the rotor by adding additional force to that normally acting thereon from the wind. This type of wind turbine is non-self-starting due to the high starting torque requirement. A Savonius wind turbine S has a typical efficiency of 15%. Thus, it is preferred in low voltage applications and low power application, such as pumping water.

Although the efficiency of a Savonius-type wind turbine is relatively low, it is believed that the efficiency thereof may be increased by reducing some of the negative drag present in such a wind turbine. Thus, a vertical wind turbine solving the aforementioned problems is desired.

### SUMMARY OF THE INVENTION

The vertical wind turbine is provided with a rotating vane housing mounted between an upper, cam disk and a lower, base disk, the base disk being mounted to a shaft. A plurality of turbine blades are pivotally mounted around the vane housing, each of the blades being pivotal between open and closed positions with respect to the housing. The cam disk defines a cam profile. A follower is coupled to each turbine blade. The follower forces the connected blade to open or close as the follower travels along the cam profile during each revolution of the housing. The open position of the blade harnesses wind energy to induce torque for rotating the housing. The closed position of the blade reduces drag to increase efficiency of the vertical wind turbine.

These and other features of the present invention will become readily apparent upon further review of the following specification and drawings.

### BRIEF DESCRIPTION OF THE DRAWINGS

FIG. 1 is an environmental perspective view of a vertical wind turbine according to the present invention.

FIG. 2 is a top view of the vertical wind turbine of FIG. 1.

FIG. 3 is a bottom view of an alternative embodiment of a cam disk for the vertical wind turbine of FIG. 1.

FIG. 4 is a top view of another alternative embodiment of a cam disk for the vertical wind turbine of FIG. 1.

FIG. 5 is a perspective view of a vertical wind turbine of the prior art.

Similar reference characters denote corresponding features consistently throughout the attached drawings.

### DETAILED DESCRIPTION OF THE PREFERRED EMBODIMENTS

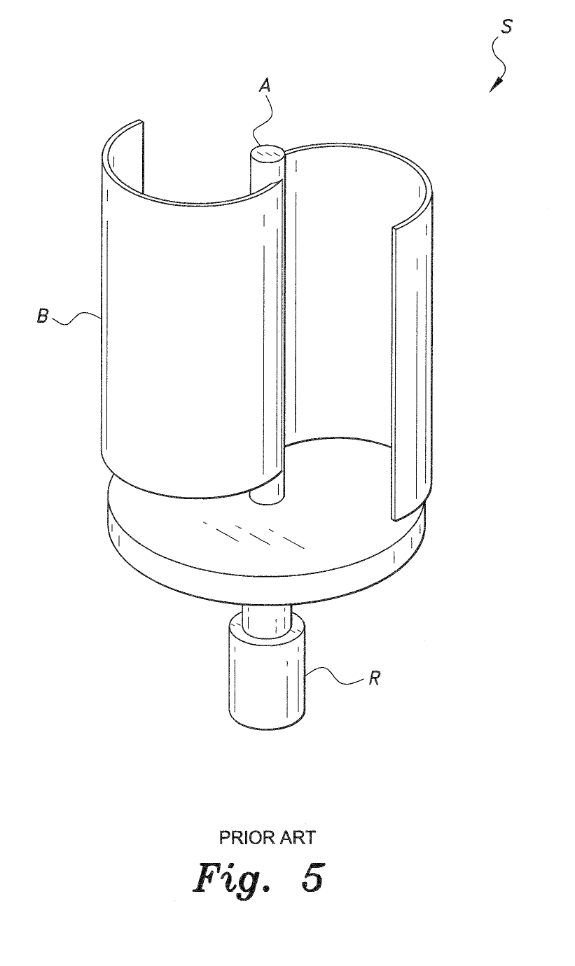

The vertical wind turbine, generally referred to by the reference number 10 in the Figures, provides a continuous means of controlling the angular position of the blades to reduce negative drag and increase efficiency. In a typical Savonius wind turbine, as shown in FIG. 5, the negative drag is caused by the wind flowing against the convex face of the blade or vane B, which retards the full rotating torque potential that can be achieved by wind striking the concave face of the adjacent blade B. One of the reasons can be attributed to the blades B being fixed in relative position on the shaft A with respect to the overall turbine. Thus, the blades B cannot move or change angular position to relieve or reduce drag.

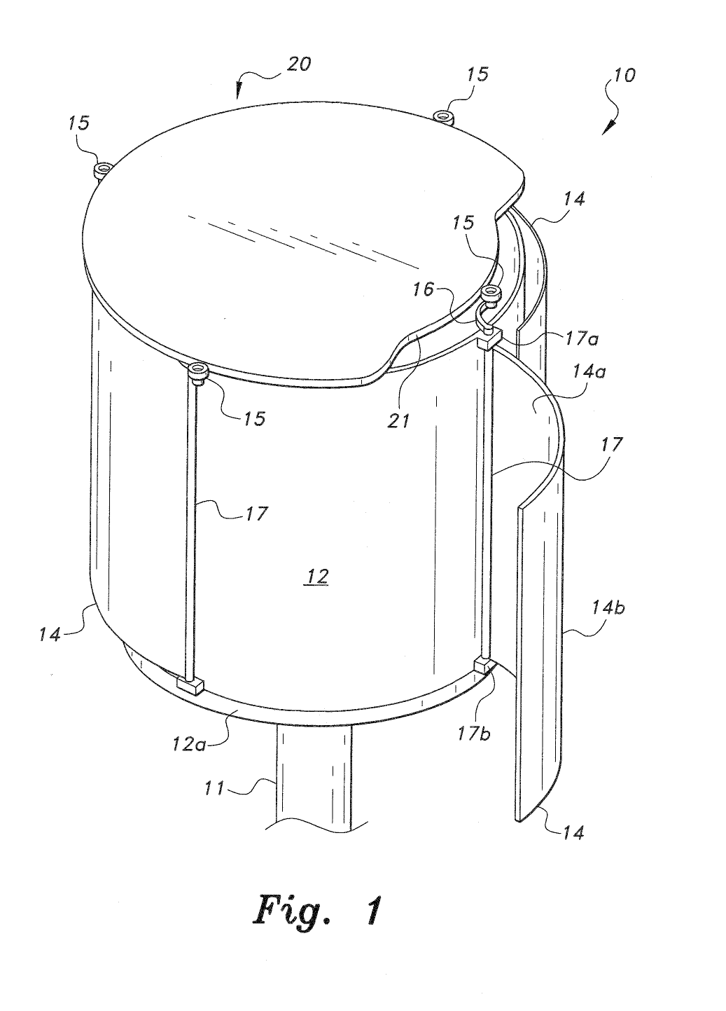

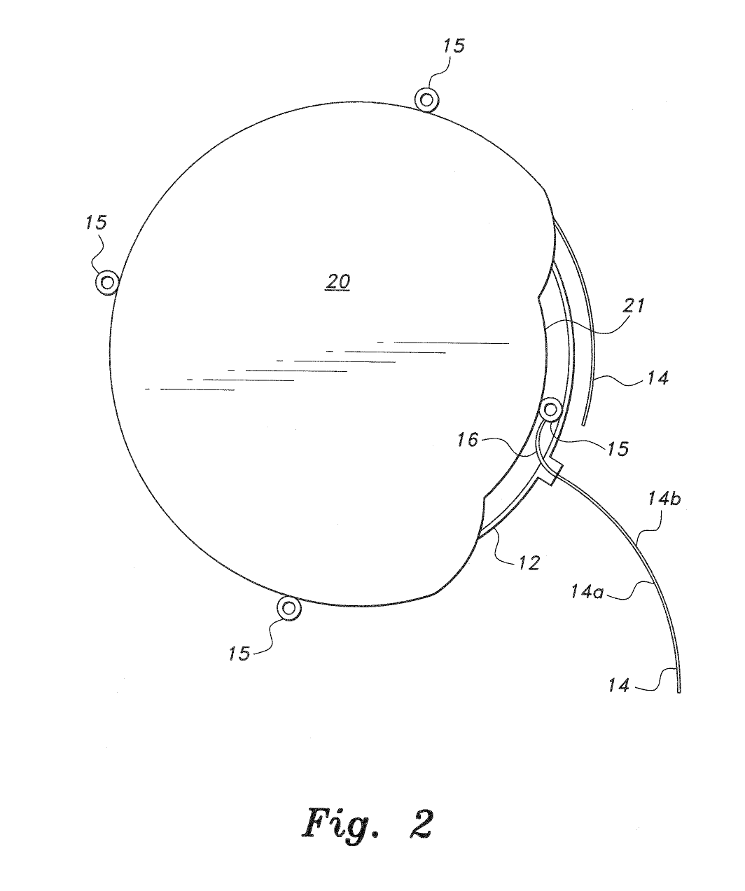

As best seen in FIGS. 1 and 2, the vertical wind turbine 10 includes an axle or shaft 11 and a rotating vane housing 12 mounted thereon between a lower, base disk 12a and an upper, cam disk 20. The shaft 11 is rotatably mounted in a bearing or the like and defines a vertical axis of rotation for the vertical wind turbine 10. The shaft 11 is coupled to an output, such as a generator. The vane housing 12 is preferably a hollow cylinder configured to rotate with the shaft 11. The base disk 12a is fixed to the vane housing 12.

A plurality of turbine vanes or blades 14 are pivotally mounted to the exterior of the vane housing 12. Each turbine blade 14 is preferably an elongate, arcuate plate having an inner, generally concave face 14a and an outer, generally convex face 14b. The concave face 14a captures the airstream of the incoming wind to induce torque on the housing 12 and rotate the same during operation. One side of each turbine blade 14 is rigidly attached to an elongate pivot pin 17. Each pivot pin 17 is pivotally supported between an upper pivot support bracket or tab 17a and a lower pivot support bracket or tab 17b extending radially from the top and bottom of the housing 12, respectively. This configuration permits each turbine blade 14 to pivot between open and closed positions with respect to the exterior of the housing 12 during a complete revolution of the housing 12. In the open position shown in FIG. 1, each turbine blade 14 is at its optimal wind-capturing angular position to generate torque. The closed position greatly reduces the potential drag from the wind stream by collapsing the blade 14 against the housing 12. It can be seen from FIGS. 1 and 2 that if all the turbine blades 14 assumed a closed open, they form a general, cylindrical shell around the housing 12.

To facilitate opening and closing operations of each turbine blade 14, the vertical wind turbine 10 is provided with a cam mechanism. The cam mechanism includes the cam disk 20 and a roller follower 15 coupled to the pivot pin 17 of each turbine blade 14. The cam disk 20 is a generally circular disk having a curvilinear cutout along an arcuate segment of the cam disk 20, defining a non-circular cam profile 21 along the periphery. The cam disk 20 is stationary with respect to the housing 12. Each follower 15 is coupled to the corresponding pivot pin 17 by a follower arm 16 so that as the follower 15 rolls along the cam profile 21, the follower 15 causes the follower arm 16 to pivot the connected pivot pin 17 and vary the angular position of the turbine blade 14.

In use, during each revolution of the housing 12, each turbine blade 14 remains substantially closed for a major angular segment of the revolution. Each turbine blade 14 begins to open as the follower 15 enters the curvilinear cutout section of the cam profile 21 and fully opens in an arcuately projecting central portion of the cam profile 21. The turbine blade 14 closes as the follower 15 exits the cutout section. Any wind striking the concave face 14a of the blade 14 causes the shaft 11 and housing 12 to rotate, while adjacent blades 14 remain closed and collapsed against the housing 12, thereby diminishing drag. Inertia causes the housing 12 to continue to rotate until the roller follower 15 of the next adjacent blade 14 follows the cam profile, extending the next adjacent blade 14 to the open position so that its concave face 14a catches the wind to further drive rotation of the housing 12 and shaft 11, thereby generating power.

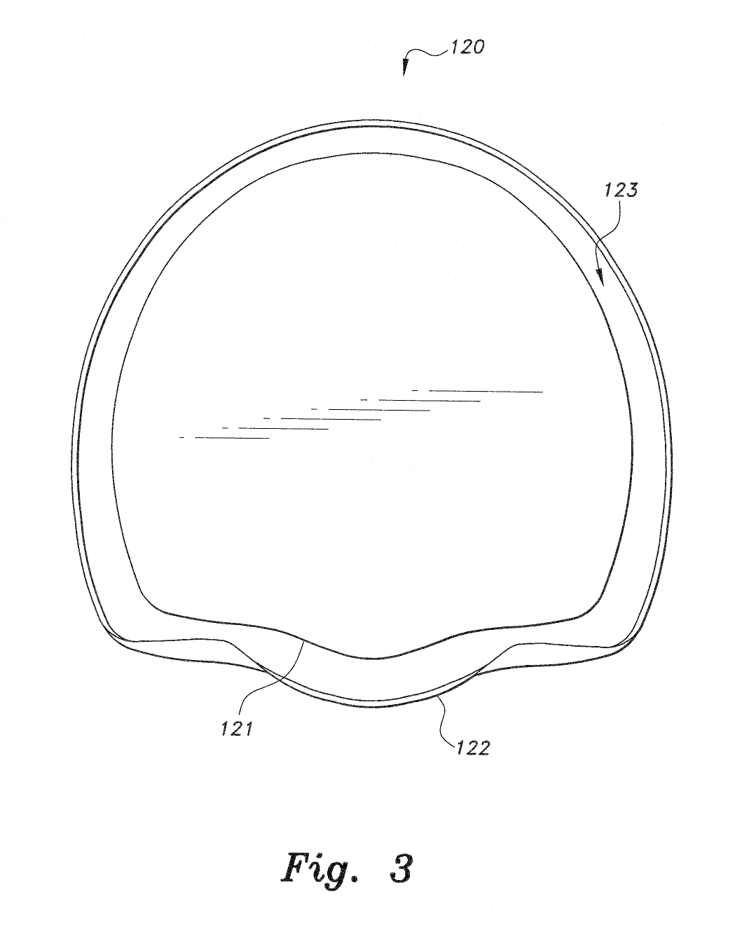

Another embodiment of a cam disk 120 is shown in FIG. 3. In this embodiment, the cam disk 120 is constructed to better confine the movement of the cam follower 15. The cam disk 120 is a generally circular disk having an inner cam profile 121 substantially similar to the cam profile 21. An outer cam profile 122 surrounds the inner cam profile 121, the outer cam profile 122 having the same general contour as the inner cam profile 121. The space between the inner cam profile 121 and the outer cam profile 122 defines a cam groove 123 for the roller follower 15 to travel in. Thus, as the follower 15 travels within the cam groove 123 during a full revolution, the follower 15 causes the connected turbine blade 14 to open and close in the same manner described above.

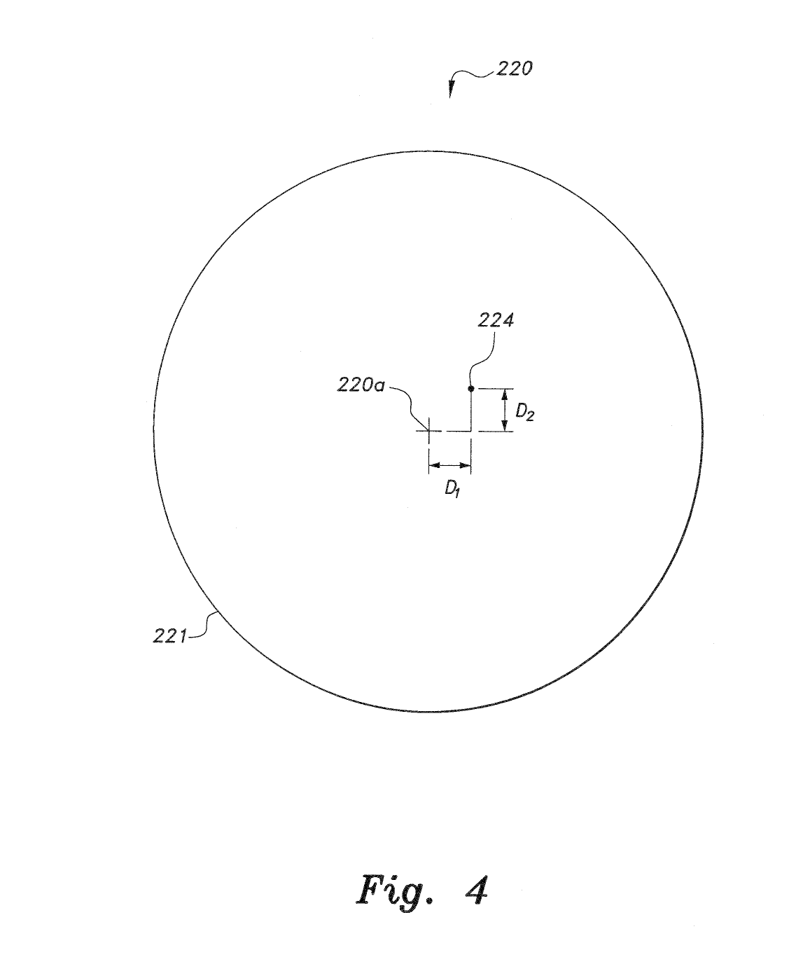

A further embodiment of a cam disk 220 is shown in FIG. 4. In this embodiment, the cam disk 220 serves as an eccentric circular cam. The cam disk 220 is a generally circular disk without a curvilinear cutout section. The cam disk 220 is positioned so that an offset point 224 is coaxial with the axis of rotation of the housing 12, the offset point 224 being spaced from a true center 220a of the cam disk 220. The periphery of the cam disk 220 defines a cam profile 221 for the roller follower 15 to engage and travel thereon. In all other respects, the cam profile 221 facilitates opening and closing of the turbine blades 14 as in the previous embodiments.

It is to be understood that the present invention is not limited to the embodiments described above, but encompasses any and all embodiments within the scope of the following claims.

We claim:

1. A vertical wind turbine, comprising:
a rotatably mounted vertical shaft, the vertical shaft defining a vertical axis of rotation;
a base disk mounted to the vertical shaft;
a cam disk spaced from the base disk, the cam disk having a periphery defining a cam profile, the cam disk being stationary;
a vane housing mounted for rotation with the shaft, the housing extending between the base disk and the cam disk;
a plurality of adjacent turbine blades pivotally mounted on the vane housing, each of the blades being arcuate and having a concave face and a convex face, each of the turbine blades being pivotal between an open position extending from the housing and a closed position collapsed against the vane housing; and
a corresponding cam roller follower mounted on each of the turbine blades, the cam roller follower pivoting the corresponding turbine blade to vary angular position between the closed position and the open position as the cam follower travels along the cam profile, whereby the concave face of the adjacent turbine blades successively catch the wind to rotate the shaft in the open position and pivot to the closed position to reduce drag.

2. The vertical wind turbine according to claim 1, wherein said vane housing comprises a hollow cylinder.

3. The vertical wind turbine according to claim 1, further comprising a corresponding elongate pivot pin coupling each said blade to said vane housing.

4. The vertical wind turbine according to claim 3, further comprising a plurality of bracket pairs including an upper pivot support bracket and a spaced, lower pivot support bracket, each of the brackets extending radially from said vane housing, the upper pivot support bracket and the lower pivot support bracket supporting a corresponding one of the pivot pins therebetween.

5. The vertical wind turbine according to claim 4, further comprising an elongate follower arm coupled to each said pivot pin at one end and a corresponding said roller follower being coupled to the other end of the follower arm.

6. The vertical wind turbine according to claim 1, wherein said cam disk has a curvilinear cutout section defining the cam profile to facilitate opening of said turbine blades when said vane housing rotates.

7. The vertical wind turbine according to claim 6, wherein said cam profile comprises an inner cam profile having a curvilinear cutout section and an outer cam profile having a curvilinear cutout section, the outer cam profile being spaced from and surrounding the inner cam profile to define a groove to guide the cam roller follower of each said turbine blade.

8. The vertical wind turbine according to claim 1, wherein said cam disk comprises a substantially circular disk disposed at a point eccentric to the axis of rotation of said shaft.
